(19) United States
(12) Patent Application Publication
(10) Pub. No.: US 2023/0328723 A1
(43) Pub. Date: Oct. 12, 2023

(54) STARTING BIT DETERMINATION FOR PUSCH REPETITION WITH TRANSPORT BLOCK SIZE SCALING

(71) Applicant: QUALCOMM Incorporated, San Diego, CA (US)

(72) Inventors: Jing DAI, Beijing (CN); Chao WEI, Beijing (CN); Gokul SRIDHARAN, Sunnyvale, CA (US); Chenxi HAO, Beijing (CN); Hung Dinh LY, San Diego, CA (US)

(21) Appl. No.: 18/022,502

(22) PCT Filed: Oct. 9, 2020
(86) PCT No.: PCT/CN2020/119924

§ 371 Date: Feb. 21, 2023

(51) Int. Cl. H04W 72/1268; H04L 1/00; H04W 72/21

(52) U.S. Cl. CPC H04W 72/1268; H04L 1/0061; H04W 72/21

(57) ABSTRACT

A configuration to determine a starting bit for PUSCH repetition with TBS scaling. The apparatus determines a TBS of a PUSCH transmission based at least in part on a set of PUSCH resources corresponding to a set of PUSCH repetitions for transmission over a repetition unit comprising a plurality of slots. The apparatus determines a starting bit location of each code block of the PUSCH transmission for a first slot of the plurality of slots. The apparatus determines a different starting bit location of each code block of the PUSCH transmission for each slot of the plurality of slots following the first slot, wherein each of the different starting bit locations for each slot following the first slot is based on a two level RV cycling. The apparatus transmits the PUSCH repetitions, each slot comprising encoded data based on respective starting bit locations.

### BACKGROUND

### Technical Field

The present disclosure relates generally to communication systems, and more particularly, to a configuration to determine a starting bit for physical uplink shared channel (PUSCH) repetition with transport block size (TBS) scaling.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a UE. The device may be a processor and/or a modem at a UE or the UE itself. The apparatus determines a transport block size (TBS) of a physical uplink shared channel (PUSCH) transmission based at least in part on a set of PUSCH resources corresponding to a set of PUSCH repetitions for transmission over a repetition unit comprising a plurality of slots. The apparatus determines a starting bit location of the PUSCH transmission for a first slot of the plurality of slots. The apparatus determines a different starting bit location of the PUSCH transmission for each slot of the plurality of slots following the first slot, wherein each of the different starting bit locations for each slot following the first slot is based on a two level redundancy version (RV) cycling. The apparatus transmits the PUSCH repetitions, each slot comprising encoded data based on respective starting bit locations.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 illustrates an example of a multi-slot PUSCH.

FIG. 5 illustrates an example of RV mapping.

FIGS. 6A-6B illustrate examples of slot mapping.

FIG. 7 illustrates an example of an RV cycle.

FIG. 8 illustrates an example of slot mapping.

FIG. 9 is a call flow diagram of signaling between a UE and a base station.

FIG. 10 is a flowchart of a method of wireless communication.

FIG. 11 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

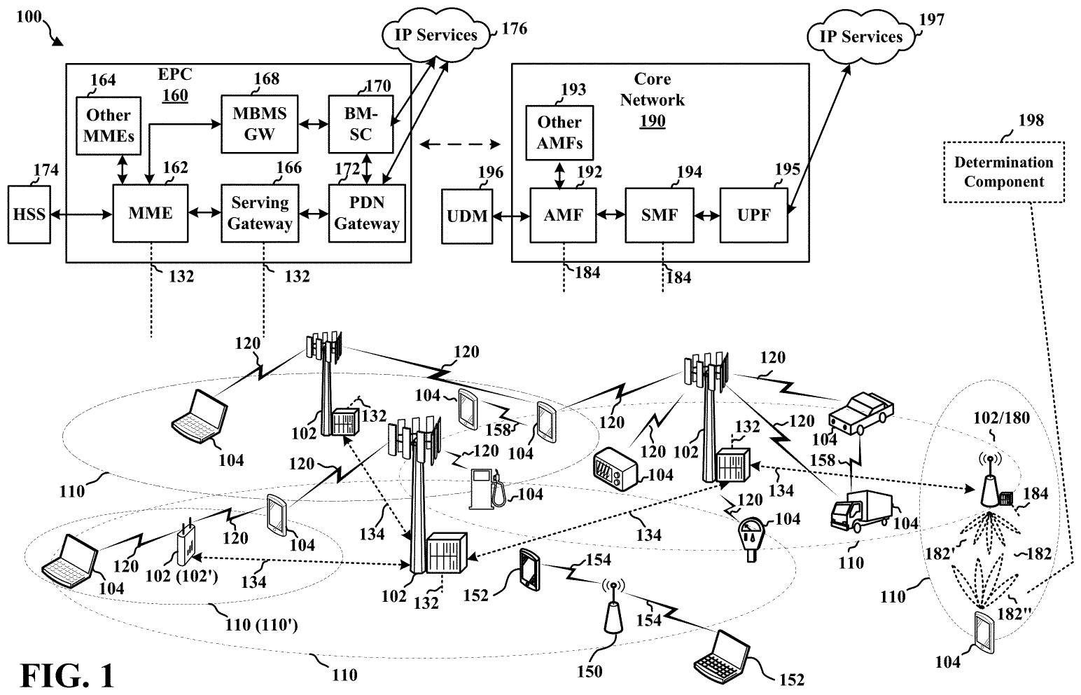

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., 51 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz — 52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may be configured to determine starting bit locations of slots of a PUSCH transmission using two level RV cycling. For example, the UE 104 may comprise a determination component 198 configured to determine starting bit locations of slots of a PUSCH transmission using two level RV cycling. The UE 104 may determine a transport block size (TB S) of a physical uplink shared channel (PUSCH) transmission based at least in part on a set of PUSCH resources corresponding to a set of PUSCH repetitions for transmission over a repetition unit comprising a plurality of slots. The UE 104 may determining a starting bit location of the PUSCH transmission for a first slot of the plurality of slots. The UE 104 may determining a different starting bit location of the PUSCH transmission for each slot of the plurality of slots following the first slot, wherein each of the different starting bit locations for each slot following the first slot is based on a two level redundancy version (RV) cycling. The UE 104 may transmit the PUSCH repetitions, each slot comprising encoded data based on respective starting bit locations.

Although the following description may be focused on 5G NR, the concepts described herein may be applicable to other similar areas, such as LTE, LTE-A, CDMA, GSM, and other wireless technologies.

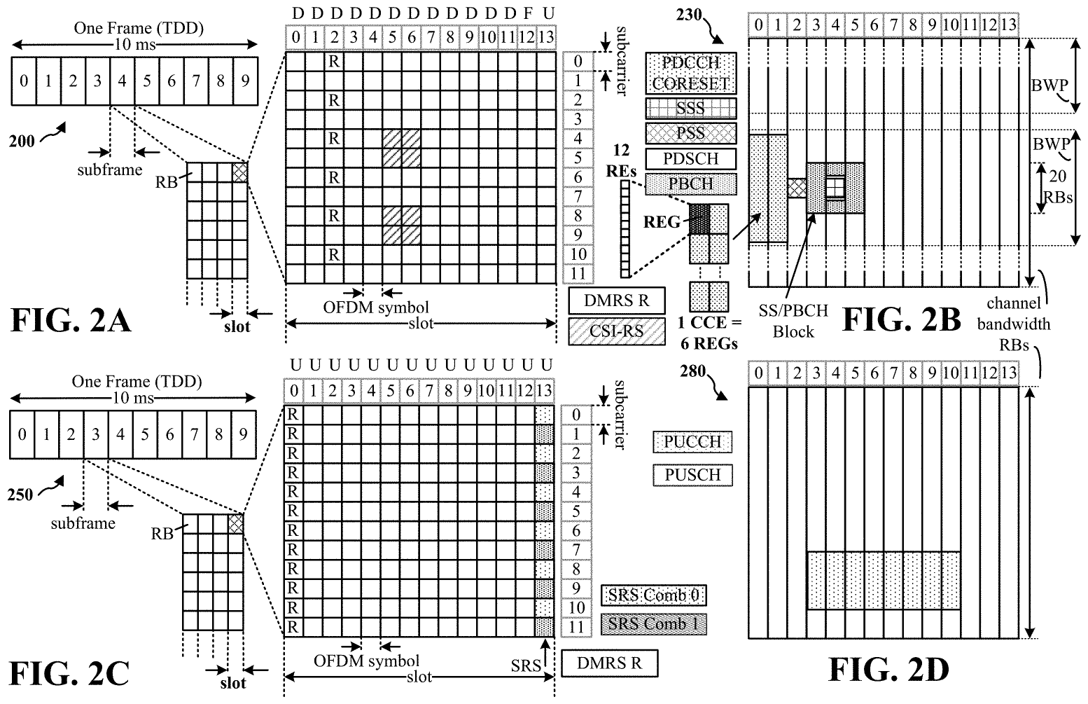

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARD) acknowledgment (ACK) (HARQ-ACK) information (ACK/negative ACK (NACK)) feedback. The PUSCH carries data, and may additionally be used to carry a buffer status report (BSR), a power headroom report (PHR), and/or UCI.

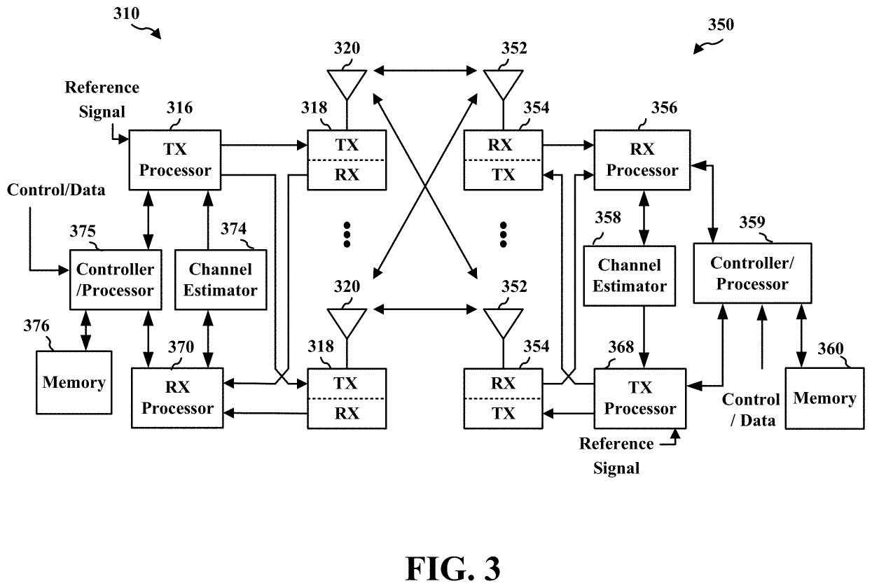

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate an RF carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

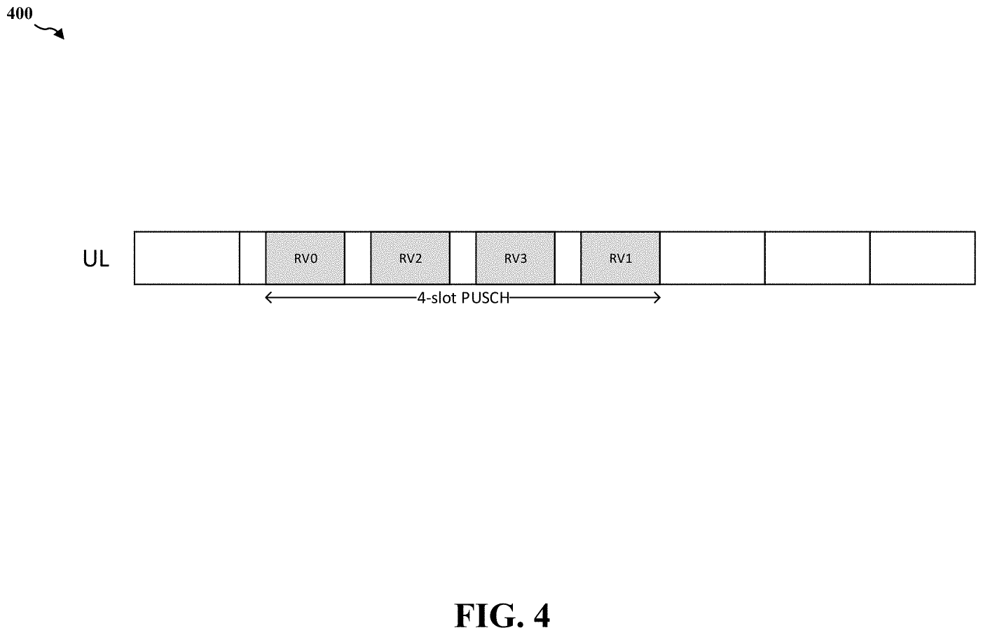

FIG. 4 illustrates an example 400 of a multi-slot PUSCH. In 5G NR, repeated transmission of PUSCH over successive slots (e.g., slot-repetition, aggregation, or multi-slot PUSCH) may be supported to increase the signal-to-noise ratio (SNR) for transmission reliability. For example, the modulation and coding scheme (MCS) and resource allocation may be indicated in scheduling downlink control information (DCI), and may be common over the successive slots. For each slot of the multi-slot PUSCH, the transmission block (TB) may be the same, but the encoded bits can differ such that the redundancy version (RV) of each slot can be different. For instance, the RV of a first slot may be indicated in the scheduling DCI, while the RV of another slot (n) may be determined by n mod 4′. In some implementations, an example RV over slots for a new transmission of a 4-slot PDSCH may include RV0, RV2, RV3, and RV1. Another example RV over slots of a retransmission of a 4-slot PDSCH may include RV3, RV1, RV0, and RV2. Further, a PUSCH repetition may be applied to coverage limited scenario.

A TB size (TBS) may be determined with PUSCH resources of a single slot, such as but not limited to multi-slot PUSCH (e.g., PUSCH repetition), and may be expressed as TBS+L_{CRC}≈N_{RE}·R·Qₘ, where R and Qₘ are code rate and modulation order indicated by MCS respectively, and N_{RE} is the total number of data REs of PUSCH in a single slot. This may result in a very low effective code rate for a multi-slot PUSCH R_{eff,multi-slot}=R/M, where M is the number of slots.

However, for uplink coverage limited scenarios, where the transmit power of the UE may be the bottleneck, further lowering down of an already low effective code rate R_{eff} may be harmful to the transmission reliability, and may cost more resources and/or bandwidth. For example, a double bandwidth associated with a R_{eff}/2 may lower down the power spectrum density (PSD) by 3 dB for uplink with limited transmit power. As such, SNR may be lowered down by 3 dB. Although the combining gain of the R_{eff}/2 may generally be assumed to be 3 dB, the channel estimation loss due to a lower SNR makes this gain less than 3 dB and may not compensate for the SNR loss.

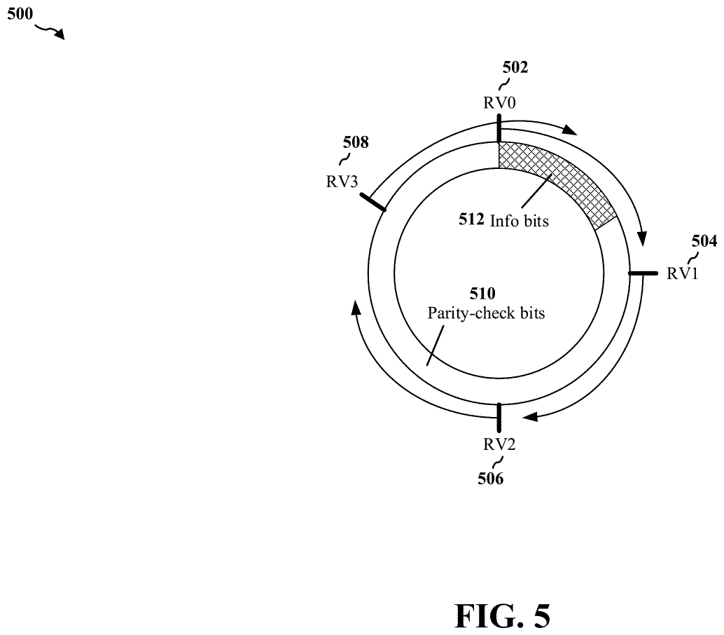

FIG. 5 illustrates an example 500 of RV mapping. For RV mapping, the starting bit of each RV (e.g., RV0 502, RV1 504, RV2 506, RV3 508) may be defined at the corresponding location of the low density parity check (LDPC) code. The 4 RVs (e.g., 502, 504, 506, 508) may have a different starting bit location and may be defined as follows:

TABLE 1

| RV | BG1 | BG2 |
|---|---|---|
| 0 | 0 | 0 |
| 1 | $⌊ \frac{17 {N}_{cb}}{66 {Z}_{c}} ⌋ {Z}_{c}$ | $⌊ \frac{13 {N}_{cb}}{50 {Z}_{c}} ⌋ {Z}_{c}$ |
| 2 | $⌊ \frac{33 {N}_{cb}}{66 {Z}_{c}} ⌋ {Z}_{c}$ | $⌊ \frac{25 {N}_{cb}}{50 {Z}_{c}} ⌋ {Z}_{c}$ |
| 3 | $⌊ \frac{56 {N}_{cb}}{66 {Z}_{c}} ⌋ {Z}_{c}$ | $⌊ \frac{43 {N}_{cb}}{50 {Z}_{c}} ⌋ {Z}_{c}$ |

Z_{c} is the lifting size, and N_{cb} is the circular buffer length. For smaller TBS, N_{Cb}=66Z_{c}, for base graph (BG) 1, and N_{cb}=50Z_{c} for BG2. The starting bit locations of all RVs may be at integer multiples of the lifting size Z_{c}.

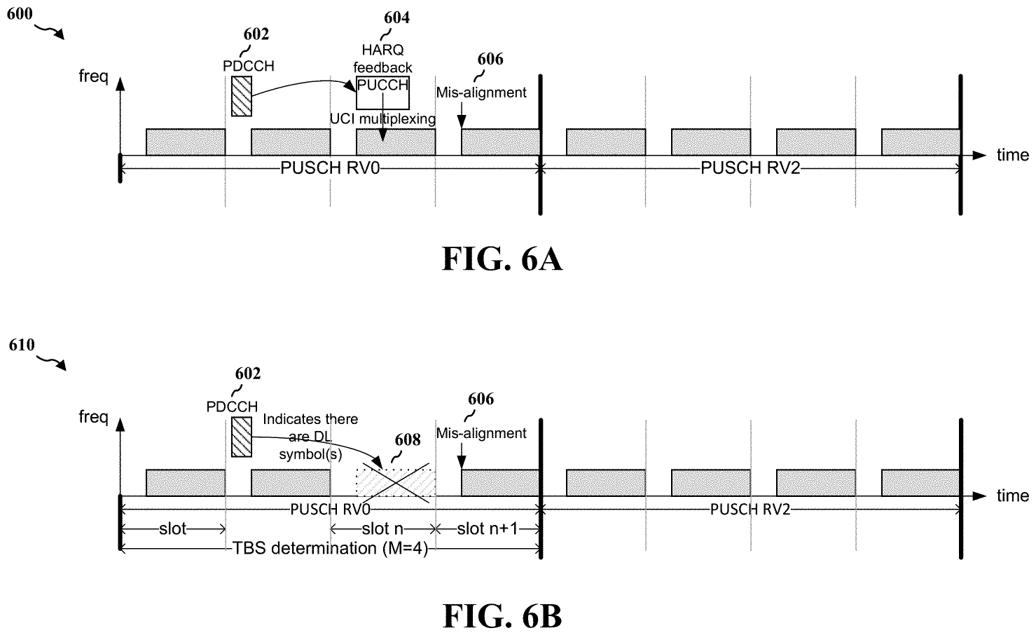

For TBS determined by PUSCH resources over multiple slots (e.g., M slots (M>1), TBS scaling with an integer scaling factor M), at least one manner of mapping encoded bits onto data REs may include continuous mapping, which may comprise the starting bit of each code block in slot n+1 being determined by the ending bit of a previous slot n. However, in some instances, such as in examples 600, 610 of FIGS. 6A, 6B, respectively, with DCI misdetection may result in misalignment between the base station and UE.

With reference to example 600 of FIG. 6A, a misdetection of a downlink scheduling (e.g., PDCCH 602) with a HARQ feedback PUCCH 604 overlapping with one of the slots, may result in misalignment (e.g., 606) based on whether there is a UCI (e.g., HARQ feedback and/or CSI) multiplexed on the overlapping slot n, which may correspond to a different rate-matching on slot n and may result in a different ending bit. In such instances, the slot n+1 may have a different starting bit for each code block, due in-part to the different ending bit of the slot n.

With reference to example 610 of FIG. 6B, in a TDD system, misdetection of a dynamic slot format indicator (SFI) (e.g., PDCCH 602) indicating downlink symbol(s) in one slot, may result in misalignment (e.g., 606) based on whether a transmission in a slot n is dropped (e.g., 608), which may correspond to a different starting bit for each code block in slot n+1.

Aspects presented herein provide a configuration for an improved manner to determine a starting bit for PUSCH with TBS scaling. The configuration may allow a UE to utilize a two level RV cycling to determine starting bit locations.

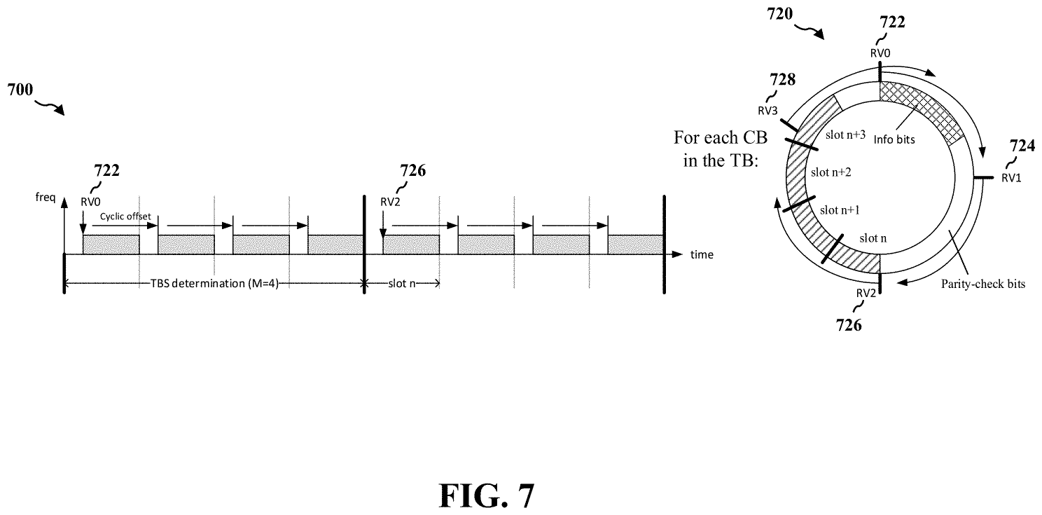

FIG. 7 illustrates an example of a multi-slot PUSCH 700 and an example of an RV cycle 720. The RV cycle 720 may comprise a two level RV cycle, where the starting bit location of each code block of each M-slot-unit as an outer level, while the starting bit location of each code block of each slot within the M-slot-unit as an inner level, where different starting bit locations may be determined for the inner level RV than the outer level RV. The RV cycle 702 may set starting bit locations for each RV (e.g., RV0 722, RV1 724, RV2 726, RV3 728). In some aspects, a fixed (e.g., cyclic) offset may be between two consecutive slots within an M-slot-unit. In some aspects, the starting bit location may not be an integer multiple of a lifting size L. In some aspects, an offset between consecutive slots may be determined by a circular buffer size N_{cb}. For example, the cyclic offset for BG1 and BG2 may be defined as follows:

TABLE 2

| | BG1 | BG2 |
|---|---|---|
| Cyclic offset | $⌊ \frac{{N}_{cb}}{3 M} ⌋ , i . e . ⌊ \frac{22 {Z}_{c}}{M} ⌋$ | $⌊ \frac{{N}_{cb}}{5 M} ⌋ , i . e . ⌊ \frac{10 {Z}_{c}}{M} ⌋$ |

In some aspects, the offset may be larger than

$$⌊ \frac{22 {Z}_{c}}{M} ⌋$$

### for BG1 or

$$⌊ \frac{10 {Z}_{c}}{M} ⌋$$

for BF2, as defined in Table 3, wherein standard-defined scaling factors β₁>1 and β₂>1. The determination of the starting bit location of outer level RVs (e.g., each M-slot-unit), and inner level RVs (e.g., each slot other than a first slot in the M-slot-unit) may be different.

TABLE 3

| | BG1 | BG2 |
|---|---|---|
| Cyclic offset | $⌊ {β}_{1} \cdot \frac{22 {Z}_{c}}{M} ⌋$ | $⌊ {β}_{2} \cdot \frac{10 {Z}_{c}}{M} ⌋$ |

In some aspects, the offset may be determined by TBS and may be indicated by coding rate R, for example, the offset may be

$$⌊ \frac{TBS}{C \cdot M \cdot R} ⌋ ,$$

where C is the number of code blocks. Another example, the offset may be

$$⌊ α \cdot \frac{TBS}{C \cdot M \cdot R} ⌋ ,$$

where α is a standard-defined scaling factor and 0<α<1.

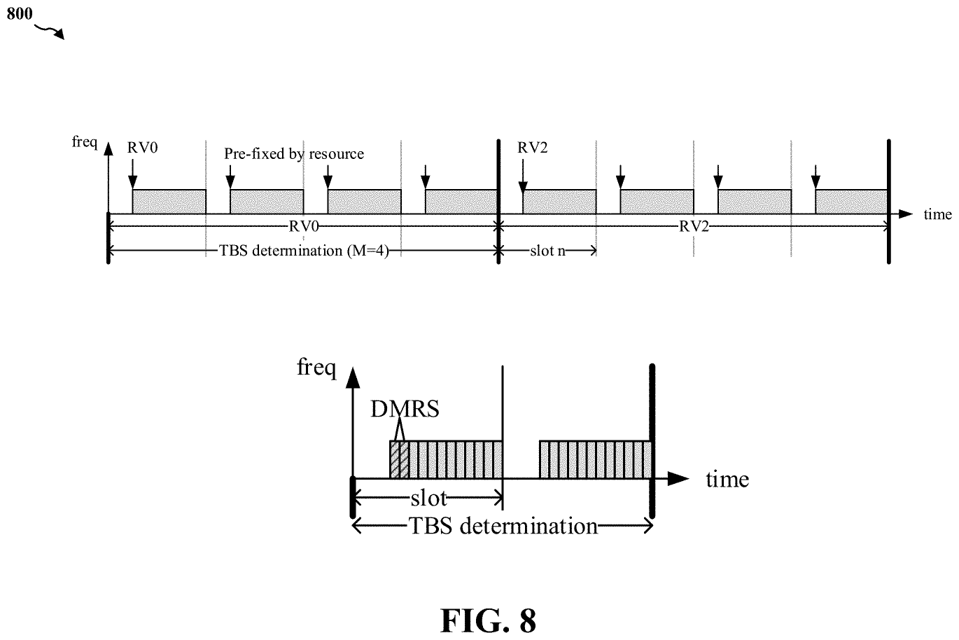

FIG. 8 illustrates an example 800 of slot mapping. In some aspects, the slot mapping may comprise a pre-fixed continuous mapping. The pre-fixed continuous mapping may be similar to continuous mapping, but with pre-fixed starting bit locations based on the scheduled resources of each slot. Pre-fixing the starting bit location of each slot within the M-slot-unit for TBS determination by the number of data REs within each slot. Pre-fixing the starting bit locations may not be changed for different ending bit location of a previous slot due to an undetected downlink scheduling or a misdetection of a dynamic SFI, as discussed above in FIGS. 6A and 6B.

In some aspects, for example, for a slot m (0≤m≤M−1) within the M-slot-unit, the starting bit location may be determined with a cyclic offset m·G to the starting bit location of the M-slot-unit, where G is the number of bits in each slot that may be mapped (e.g., G=N_{RE}·Qₘ·v, where N_{RE} is the number of date REs per slot, and Qₘ is the modulation order, v is the number of MIMO layers).

In some aspects, for example, for slots m (0≤m≤M−1) in the M-slot-unit, the starting bit location may be determined with an accumulated cyclic offset Σᵢ₌₀^{m}Gᵢ, where Gᵢ is the number of bits in slot i that can be mapped (e.g., Gᵢ=N_{RE,i}·Qₘ·v, where N_{RE,i} is the number of date REs in slot i). The accumulated cyclic offset may be utilized for non-uniform DMRS over slots, where different N_{RE} is associated with each slot. In some aspects, the accumulated cyclic offset may not result in an integer number of lifting size Z_{c} at the starting bit location of each slot.

In some aspects, such as for single-slot PUCCH with HARQ-ACK overlapping with multi-slot PUSCH with TBS scaling, encoded HARQ-ACK bits may puncture the PUSCH when mapping to REs for instances where the HARQ-ACK comprise greater than 2 bits of HARQ-ACK. The 2 bits may comprise information bits, which may be different from the encoded HARQ-ACK bits. In some aspects, such as for single-slot PUCCH overlapping with multi-slot PUSCH with TBS scaling, UCI multiplexing may not be applied. In such aspects, the PUSCH may be dropped with the overlapping slot, due in-part to PUSCH having a lower priority than PUCCH. The UE may not expect a slot within the M-slot-unit starting with RV0 that overlaps with a single-slot PUCCH. RV0 may comprise information bits and the performance may degrade if some parts are dropped.

In some aspects, the RV mapping of multi-slot PUSCH with TBS scaling, the pre-fixed starting bit location or the continuous mapping may be configured via RRC signaling. In some aspects, the TBS scaling of the multi-slot PUSCH may be limited to a single-code block (CB) case, due to TB sized over M slots with 2 CBs may not have a benefit with respect to TB sized over M/2 slots with a single-CB. The UE may not expect TBS scaling to be used for a TBS above a threshold, e.g., 3824 for BG2 or 8424 for BG1, above which TB may need to be segmented into more than one CB.

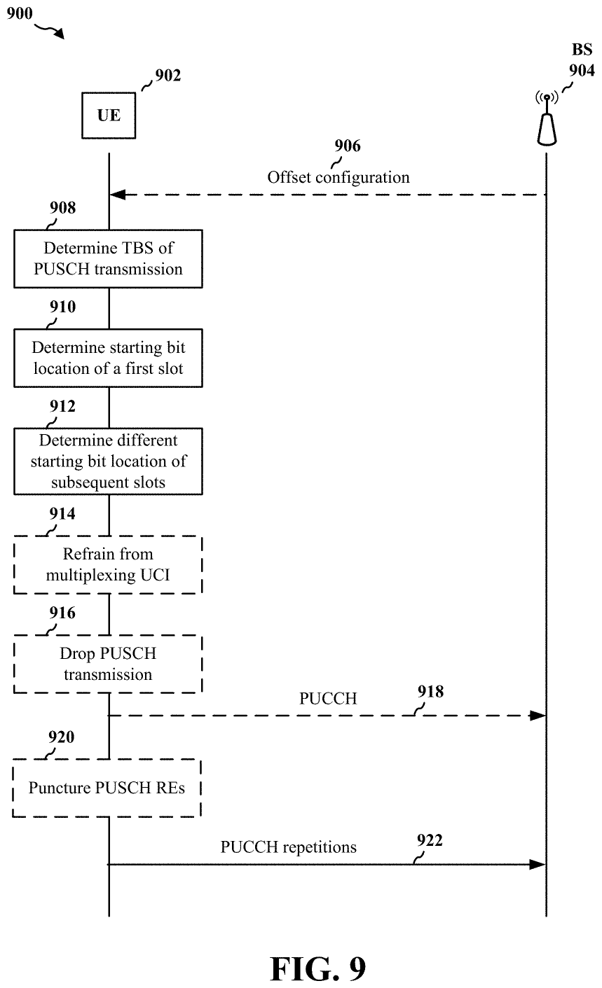

FIG. 9 is a call flow diagram 900 of signaling between a UE 902 and a base station 904. The base station 504 may be configured to provide at least one cell. The UE 902 may be configured to communicate with the base station 904. For example, in the context of FIG. 1, the base station 904 may correspond to base station 102/180 and, accordingly, the cell may include a geographic coverage area 110 in which communication coverage is provided and/or small cell 102′ having a coverage area 110′. Further, a UE 902 may correspond to at least UE 104. In another example, in the context of FIG. 3, the base station 904 may correspond to base station 310 and the UE 902 may correspond to UE 350. Optional aspects are illustrated with a dashed line.

In some aspects, for example as illustrated at 906, the UE 902 may receive a configuration to apply an offset bit location. The UE 902 may receive the configuration to apply the offset bit location for RV mapping of a PUSCH transmission. The UE 902 may receive the configuration to apply the offset bit location from the base station 904. In some aspects, the configuration may be received in radio resource control (RRC) signaling that indicates whether to use the offset bit location or a continuous mapping.

As illustrated at 908, the UE 902 may determine a TBS of the PUSCH. The UE 902 may determine the TBS of the PUSCH based at least in part on a set of PUSCH resources corresponding to a set of PUSCH repetitions for transmission over a repetition unit comprising a plurality of slots. In some aspects, the UE 902 may determine the TBS based on that the TB comprises a single code block. In some aspects, the UE 902 does not determine the TBS based on the plurality of slots for the TB comprising multiple code blocks.

As illustrated at 910, the UE 902 may determine a starting bit location of each code block of the PUSCH transmission. The UE 902 may determine the starting bit location of the PUSCH transmission for a first slot of the plurality of slots.

As illustrated at 912, the UE 902 may determine a different starting bit location of each code block of the PUSCH transmission for each slot of the plurality of slots following the first slot. Each of the different starting bit locations for each slot following the first slot may be based on a two level RV cycling. In some aspects, the UE 902 may apply a cyclic offset between code block start bits of consecutive slots within the plurality of slots. The cyclic offset may be the same among any two consecutive slots within the plurality of slots. In some aspects, the cyclic offset may not be an integer multiple of a lifting size (Zc) of a low density parity check (LDPC) code. In some aspects, the cyclic offset may be determined by a circular buffer size or a lifting size of the LDPC code. In some aspects, the cyclic offset may be based on one or more of a transmission block size (TBS) or a coding rate. In some aspects, the cyclic offset may be based at least on a number of resource elements (REs) within each slot. The cyclic offset may be a fixed offset based on the number of REs within each slot.

In some aspects, for example as illustrated at 914, the UE 902 may refrain from multiplexing uplink control information (UCI). The UE 902 may refrain from multiplexing UCI that may be conveyed with a physical uplink control channel (PUCCH) overlapping with the PUSCH transmission over the plurality of slots.

In some aspects, for example as illustrated at 916, the UE 902 may drop the PUSCH transmission. The UE 902 may drop the PUSCH transmission in a slot that may overlap with the PUCCH. In such aspect, the UE 902 may transmit the PUCCH in the slot, as illustrated for example at 918.

In some aspects, for example as illustrated at 920, the UE 902 may puncture PUSCH REs with an encoded HARQ-ACK. The UE 902 may puncture PUSCH REs with the encoded HARQ-ACK when mapping to PUSCH. The encoded HARQ-ACK may comprise greater than 2 bits of HARQ-ACK.

As illustrated at 922, the UE 902 may transmit the PUSCH repetitions. The UE 902 may transmit the PUSCH repetitions where each slot may comprise encoded data based on respective starting bit locations.

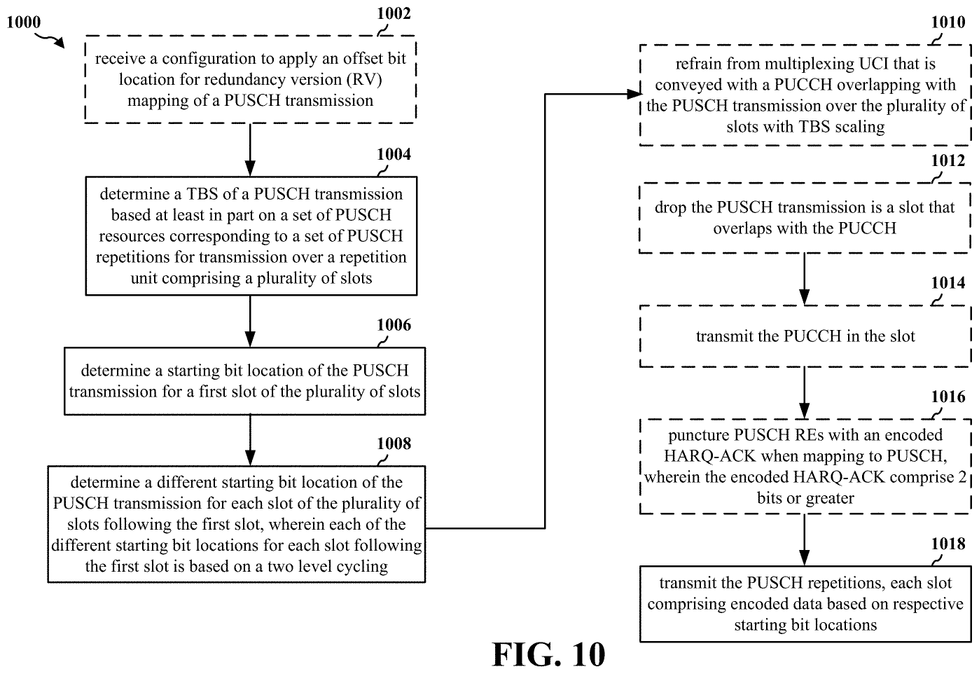

FIG. 10 is a flowchart 1000 of a method of wireless communication. The method may be performed by a UE or a component of a UE (e.g., the UE 104; the apparatus 1102; the cellular baseband processor 1104, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. Optional aspects are illustrated with a dashed line. The method may allow a UE to determine starting bit locations of slots of a PUSCH transmission using two level RV cycling.

In some aspects, for example at 1002, the UE may receive a configuration to apply an offset bit location. For example, 1002 may be performed by configuration component 1140 of apparatus 1102. The UE may receive the configuration to apply the offset bit location for RV mapping of a PUSCH transmission. The UE may receive the configuration to apply the offset bit location from a base station. In some aspects, the configuration may be received in RRC signaling that indicates whether to use the offset bit location or a continuous mapping.

At 1004, the UE may determine a TBS of the PUSCH. For example, 1004 may be performed by determination component 1142 of apparatus 1102. The UE may determine the TBS of the PUSCH based at least in part on a set of PUSCH resources corresponding to a set of PUSCH repetitions for transmission over a repetition unit comprising a plurality of slots. In some aspects, the UE may determine the TBS based on that the TB comprises a single code block. In some aspects, the UE does not determine the TBS based on the plurality of slots for the TB comprising multiple code blocks.

At 1006, the UE may determine a starting bit location of each code block of the PUSCH transmission. For example, 1006 may be performed by determination component 1142 of apparatus 1102. The UE may determine the starting bit location of each code block of the PUSCH transmission for a first slot of the plurality of slots.

At 1008, the UE may determine a different starting bit location of each code block of the PUSCH transmission for each slot of the plurality of slots following the first slot. For example, 1008 may be performed by determination component 1142 of apparatus 1102. Each of the different starting bit locations for each slot following the first slot may be based on a two level RV cycling. In some aspects, the UE may apply a cyclic offset between code block start bits of consecutive slots within the plurality of slots. The cyclic offset may be the same among any two consecutive slots within the plurality of slots. In some aspects, the cyclic offset may not be an integer multiple of a lifting size Zc of a LDPC code. In some aspects, the cyclic offset may be determined by a circular buffer size or a lifting size of the LDPC code. In some aspects, the cyclic offset may be based on one or more of a transmission block size (TBS) or a coding rate. In some aspects, the cyclic offset may be based at least on a number of resource elements (REs) within each slot. The cyclic offset may be a fixed offset based on the number of REs within each slot.

In some aspects, for example at 1010, the UE may refrain from multiplexing UCI. For example, 1010 may be performed by refrain component 1144 of apparatus 1102. The UE may refrain from multiplexing UCI that may be conveyed with a PUCCH overlapping with the PUSCH transmission over the plurality of slots.

In some aspects, for example at 1012, the UE may drop the PUSCH transmission. For example, 1012 may be performed by drop component 1146 of apparatus 1102. The UE may drop the PUSCH transmission in a slot that may overlap with the PUCCH.

In some aspects, for example at 1014, the UE may transmit the PUCCH. For example, 1014 may be performed by PUCCH component 1148 of apparatus 1102. The UE may transmit the PUCCH in the slot.

In some aspects, for example at 1016, the UE may puncture PUSCH REs with an encoded HARQ-ACK. For example, 1016 may be performed by puncture component 1150 of apparatus 1102. The UE may puncture PUSCH REs with the encoded HARQ-ACK when mapping to PUSCH. The encoded HARQ-ACK may comprise greater than 2 bits of HARQ-ACK.

At 1018, the UE may transmit the PUSCH repetitions. For example, 1018 may be performed by repetition component 1152 of apparatus 1102. The UE may transmit the PUSCH repetitions where each slot may comprise encoded data based on respective starting bit locations.

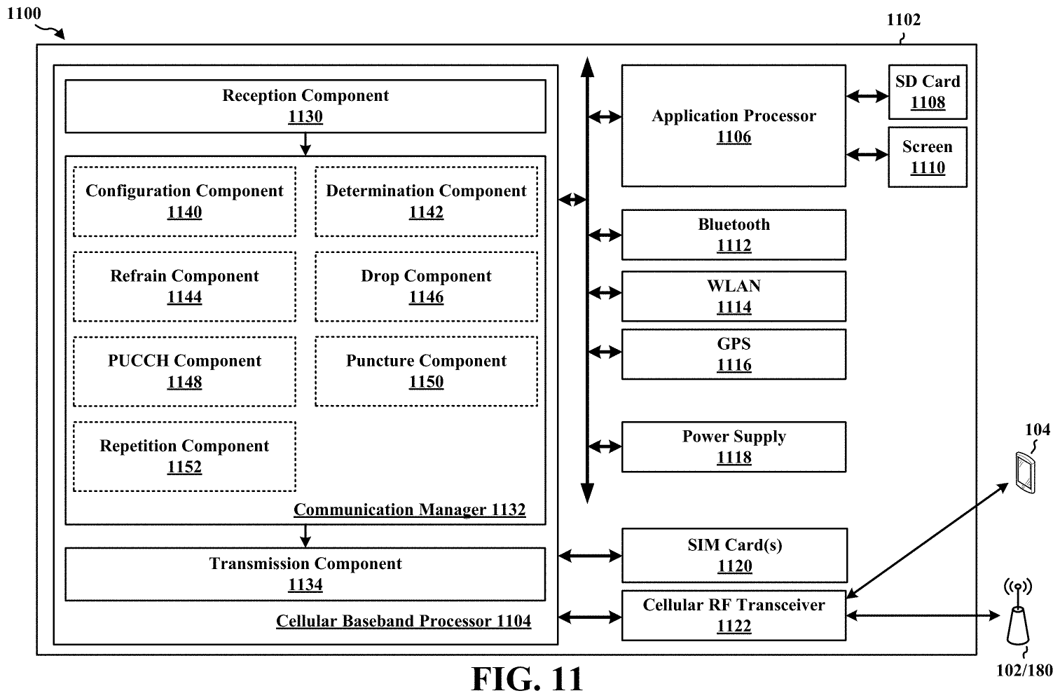

FIG. 11 is a diagram 1100 illustrating an example of a hardware implementation for an apparatus 1102. The apparatus 1102 is a UE and includes a cellular baseband processor 1104 (also referred to as a modem) coupled to a cellular RF transceiver 1122 and one or more subscriber identity modules (SIM) cards 1120, an application processor 1106 coupled to a secure digital (SD) card 1108 and a screen 1110, a Bluetooth module 1112, a wireless local area network (WLAN) module 1114, a Global Positioning System (GPS) module 1116, and a power supply 1118. The cellular baseband processor 1104 communicates through the cellular RF transceiver 1122 with the UE 104 and/or BS 102/180. The cellular baseband processor 1104 may include a computer-readable medium/memory. The computer-readable medium/memory may be non-transitory. The cellular baseband processor 1104 is responsible for general processing, including the execution of software stored on the computer-readable medium/memory. The software, when executed by the cellular baseband processor 1104, causes the cellular baseband processor 1104 to perform the various functions described supra. The computer-readable medium/memory may also be used for storing data that is manipulated by the cellular baseband processor 1104 when executing software. The cellular baseband processor 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the cellular baseband processor 1104. The cellular baseband processor 1104 may be a component of the UE 350 and may include the memory 360 and/or at least one of the TX processor 368, the RX processor 356, and the controller/processor 359. In one configuration, the apparatus 1102 may be a modem chip and include just the cellular baseband processor 1104, and in another configuration, the apparatus 1102 may be the entire UE (e.g., see 350 of FIG. 3) and include the aforediscussed additional modules of the apparatus 1102.

The communication manager 1132 includes a configuration component 1140 that is configured to may receive a configuration to apply an offset bit location, e.g., as described in connection with 1002 of FIG. 10. The communication manager 1132 further includes a determination component 1142 that is configured to determine a TBS of the PUSCH, e.g., as described in connection with 1004 of FIG. 10. The determination component 1142 may be configured to determine a starting bit location of the PUSCH transmission, e.g., as described in connection with 1006 of FIG. 10. The determination component 1142 may be configured to determine a different starting bit location of the PUSCH transmission for each slot of the plurality of slots following the first slot, e.g., as described in connection with 1008 of FIG. 10. The communication manager 1132 further includes a refrain component 1144 that is configured to refrain from multiplexing UCI, e.g., as described in connection with 1010 of FIG. 10. The communication manager 1132 further includes a drop component 1146 that is configured to drop the PUSCH transmission, e.g., as described in connection with 1012 of FIG. 10. The communication manager 1132 further includes a PUCCH component 1148 that is configured to transmit the PUCCH, e.g., as described in connection with 1014 of FIG. 10. The communication manager 1132 further includes a puncture component 1150 that is configured to puncture PUSCH REs with an encoded HARQ-ACK, e.g., as described in connection with 1016 of FIG. 10. The communication manager 1132 further includes a repetition component 1152 that is configured to transmit the PUSCH repetitions, e.g., as described in connection with 1018 of FIG. 10.

The apparatus may include additional components that perform each of the blocks of the algorithm in the aforementioned flowchart of FIG. 10. As such, each block in the aforementioned flowchart of FIG. 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1102, and in particular the cellular baseband processor 1104, includes means for determining a TBS of a PUSCH transmission based at least in part on a set of PUSCH resources corresponding to a set of PUSCH repetitions for transmission over a repetition unit comprising a plurality of slots. The apparatus includes means for determining a starting bit location of each code block of the PUSCH transmission for a first slot of the plurality of slots. The apparatus includes means for determining a different starting bit location of each code block of the PUSCH transmission for each slot of the plurality of slots following the first slot. Each of the different starting bit locations for each slot following the first slot is based on a two level RV cycling. The apparatus includes means for transmitting the PUSCH repetitions, each slot comprising encoded data based on respective starting bit locations. The apparatus further includes means for receiving a configuration to apply an offset bit location for RV mapping of the PUSCH transmission. The apparatus further includes means for refraining from multiplexing UCI that is conveyed with a PUCCH overlapping with the PUSCH transmission over the plurality of slots. The apparatus further includes means for dropping the PUSCH transmission in a slot that overlaps with the PUCCH. The apparatus further includes means for transmitting the PUCCH in the slot. The apparatus further includes means for puncturing PUSCH REs with an encoded HARQ-ACK when mapping to PUSCH. The encoded HARQ-ACK comprise greater than 2 bits of HARQ-ACK. The aforementioned means may be one or more of the aforementioned components of the apparatus 1102 configured to perform the functions recited by the aforementioned means. As described supra, the apparatus 1102 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The following aspects are illustrative only and may be combined with aspects of other embodiments or teachings described herein, without limitation.

Aspect 1 is a method of wireless communication at a UE comprising determining a TBS of a PUSCH transmission based at least in part on a set of PUSCH resources corresponding to a set of PUSCH repetitions for transmission over a repetition unit comprising a plurality of slots; determining a starting bit location of each code block of the PUSCH transmission for a first slot of the plurality of slots; determining a different starting bit location of each code block of the PUSCH transmission for each slot of the plurality of slots following the first slot, wherein each of the different starting bit locations for each slot following the first slot is based on a two level RV cycling; and transmitting the PUSCH repetitions, each slot comprising encoded data based on respective starting bit locations.

In Aspect 2, the method of Aspect 1 further includes that the UE applies a cyclic offset between code block start bits of consecutive slots within the plurality of slots.

In Aspect 3, the method of Aspect 1 or 2 further includes that the cyclic offset is the same among any two consecutive slots within the plurality of slots.

In Aspect 4, the method of any of Aspects 1-3 further includes that the cyclic offset is not an integer multiple of a lifting size (Zc) of a LDPC code.

In Aspect 5, the method of any of Aspects 1-4 further includes that the cyclic offset is determined by a circular buffer size or a lifting size of a LDPC code.

In Aspect 6, the method of any of Aspects 1-5 further includes that the cyclic offset is based on one or more of a TBS or a coding rate.

In Aspect 7, the method of any of Aspects 1-6 further includes that the cyclic offset is based at least on a number of resource elements (REs) within each slot.

In Aspect 8, the method of any of Aspects 1-7 further includes that the cyclic offset is a fixed offset based on the number of REs within each slot.

In Aspect 9, the method of any of Aspects 1-8 further includes receiving a configuration to apply an offset bit location for RV mapping of the PUSCH transmission.

In Aspect 10, the method of any of Aspects 1-9 further includes that the configuration is received in RRC signaling that indicates whether to use the offset bit location or a continuous mapping.

In Aspect 11, the method of any of Aspects 1-10 further includes that the UE determines the TBS based on that the TB comprises a single code block.

In Aspect 12, the method of any of Aspects 1-11 further includes that the UE does not determine the TBS based on the plurality of slots for the TB comprising multiple code blocks.

In Aspect 13, the method of any of Aspects 1-12 further includes refraining from multiplexing UCI that is conveyed with a PUCCH overlapping with the PUSCH transmission over the plurality of slots.

In Aspect 14, the method of any of Aspects 1-13 further includes dropping the PUSCH transmission in a slot that overlaps with the PUCCH; and transmitting the PUCCH in the slot.

In Aspect 15, the method of any of Aspects 1-14 further includes puncturing PUSCH REs with an encoded HARQ-ACK when mapping to PUSCH, wherein the encoded HARQ-ACK comprise greater than 2 bits of HARQ-ACK.

Aspect 16 is a device including one or more processors and one or more memories in electronic communication with the one or more processors storing instructions executable by the one or more processors to cause the system or apparatus to implement a method as in any of Aspects 1-15.

Aspect 17 is a system or apparatus including means for implementing a method or realizing an apparatus as in any of Aspects 1-15.

Aspect 18 is a non-transitory computer readable medium storing instructions executable by one or more processors to cause the one or more processors to implement a method as in any of Aspects 1-15.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of wireless communication at a user equipment (UE), comprising:
determining a transport block size (TBS) of a physical uplink shared channel (PUSCH) transmission based at least in part on a set of PUSCH resources corresponding to a set of PUSCH repetitions for transmission over a repetition unit comprising a plurality of slots;
determining a starting bit location of each code block of the PUSCH transmission for a first slot of the plurality of slots;
determining a different starting bit location of each code block of the PUSCH transmission for each slot of the plurality of slots following the first slot, wherein each of the different starting bit locations for each slot following the first slot is based on a two level redundancy version (RV) cycling; and
transmitting the PUSCH repetitions, each slot comprising encoded data based on respective starting bit locations.

2. The method of claim 1, wherein the UE applies a cyclic offset between code block start bits of consecutive slots within the plurality of slots.

3. The method of claim 2, wherein the cyclic offset is the same among any two consecutive slots within the plurality of slots.

4. The method of claim 3, wherein the cyclic offset is not an integer multiple of a lifting size (Zc) of a low density parity check (LDPC) code.

5. The method of claim 3, wherein the cyclic offset is determined by a circular buffer size or a lifting size of a low density parity check (LDPC) code.

6. The method of claim 3, wherein the cyclic offset is based on one or more of a transmission block size (TBS) or a coding rate.

7. The method of claim 2, wherein the cyclic offset is based at least on a number of resource elements (REs) within each slot.

8. The method of claim 7, wherein the cyclic offset is a fixed offset based on the number of REs within each slot.

9. The method of claim 1, further comprising:
receiving a configuration to apply an offset bit location for redundancy version (RV) mapping of the PUSCH transmission.

10. The method of claim 9, wherein the configuration is received in radio resource control (RRC) signaling that indicates whether to use the offset bit location or a continuous mapping.

11. The method of claim 1, wherein the UE determines the TB S based on that the TB comprises a single code block.

12. The method of claim 11, wherein the UE does not determine the TBS based on the plurality of slots for the TB comprising multiple code blocks.

13. The method of claim 1, further comprising:
refraining from multiplexing uplink control information (UCI) that is conveyed with a physical uplink control channel (PUCCH) overlapping with the PUSCH transmission over the plurality of slots.

14. The method of claim 13, further comprising:
dropping the PUSCH transmission in a slot that overlaps with the PUCCH; and
transmitting the PUCCH in the slot.

15. The method of claim 1, further comprising:
puncturing PUSCH REs with an encoded HARQ-ACK when mapping to PUSCH, wherein the encoded HARQ-ACK comprise greater than 2 bits of HARQ-ACK.

16. An apparatus for wireless communication of a user equipment (UE), comprising:
means for determining a transport block size (TBS) of a physical uplink shared channel (PUSCH) transmission based at least in part on a set of PUSCH resources corresponding to a set of PUSCH repetitions for transmission over a repetition unit comprising a plurality of slots;
means for determining a starting bit location of each code block of the PUSCH transmission for a first slot of the plurality of slots;
means for determining a different starting bit location of each code block of the PUSCH transmission for each slot of the plurality of slots following the first slot, wherein each of the different starting bit locations for each slot following the first slot is based on a two level redundancy version (RV) cycling; and
means for transmitting the PUSCH repetitions, each slot comprising encoded data based on respective starting bit locations.

17. The apparatus of claim 16, wherein the UE applies a cyclic offset between code block start bits of consecutive slots within the plurality of slots.

18. The apparatus of claim 17, wherein the cyclic offset is the same among any two consecutive slots within the plurality of slots.

19. The apparatus of claim 18, wherein the cyclic offset is not an integer multiple of a lifting size (Zc) of a low density parity check (LDPC) code.

20. The apparatus of claim 18, wherein the cyclic offset is determined by a circular buffer size or a lifting size of a low density parity check (LDPC) code.

21. The apparatus of claim 18, wherein the cyclic offset is based on one or more of a transmission block size (TBS) or a coding rate.

22. The apparatus of claim 17, wherein the cyclic offset is based at least on a number of resource elements (REs) within each slot.

23. The apparatus of claim 22, wherein the cyclic offset is a fixed offset based on the number of REs within each slot.

24. The apparatus of claim 16, further comprising:
means for receiving a configuration to apply an offset bit location for redundancy version (RV) mapping of the PUSCH transmission.

25-30. (canceled)

31. An apparatus for wireless communication of a user equipment (UE), comprising:
a memory; and
at least one processor coupled to the memory and configured to:
determine a transport block size (TBS) of a physical uplink shared channel (PUSCH) transmission based at least in part on a set of PUSCH resources corresponding to a set of PUSCH repetitions for transmission over a repetition unit comprising a plurality of slots;
determine a starting bit location of each code block of the PUSCH transmission for a first slot of the plurality of slots;
determine a different starting bit location of each code block of the PUSCH transmission for each slot of the plurality of slots following the first slot, wherein each of the different starting bit locations for each slot following the first slot is based on a two level redundancy version (RV) cycling; and
transmit the PUSCH repetitions, each slot comprising encoded data based on respective starting bit locations.

32. The apparatus of claim 31, wherein the UE applies a cyclic offset between code block start bits of consecutive slots within the plurality of slots.

33. The apparatus of claim 32, wherein the cyclic offset is the same among any two consecutive slots within the plurality of slots.

34. The apparatus of claim 33, wherein the cyclic offset is not an integer multiple of a lifting size (Zc) of a low density parity check (LDPC) code.

35. The apparatus of claim 33, wherein the cyclic offset is determined by a circular buffer size or a lifting size of a low density parity check (LDPC) code.

36. The apparatus of claim 33, wherein the cyclic offset is based on one or more of a transmission block size (TBS) or a coding rate.

37. The apparatus of claim 32, wherein the cyclic offset is based at least on a number of resource elements (REs) within each slot.

38. The apparatus of claim 37, wherein the cyclic offset is a fixed offset based on the number of REs within each slot.

39. The apparatus of claim 31, wherein the at least one processor further configured to:
receive a configuration to apply an offset bit location for redundancy version (RV) mapping of the PUSCH transmission.

40. The apparatus of claim 39, wherein the configuration is received in radio resource control (RRC) signaling that indicates whether to use the offset bit location or a continuous mapping.

41-45. (canceled)

46. A computer-readable medium storing computer executable code, the code when executed by a processor cause the processor to:
determine a transport block size (TBS) of a physical uplink shared channel (PUSCH) transmission based at least in part on a set of PUSCH resources corresponding to a set of PUSCH repetitions for transmission over a repetition unit comprising a plurality of slots;
determine a starting bit location of each code block of the PUSCH transmission for a first slot of the plurality of slots;
determine a different starting bit location of each code block of the PUSCH transmission for each slot of the plurality of slots following the first slot, wherein each of the different starting bit locations for each slot following the first slot is based on a two level redundancy version (RV) cycling; and
transmit the PUSCH repetitions, each slot comprising encoded data based on respective starting bit locations.
